(19) United States
(12) Patent Application Publication
(10) Pub. No.: US 2014/0027951 A1
(43) Pub. Date: Jan. 30, 2014

(54) CUTTING OF BRITTLE MATERIALS WITH TAILORED EDGE SHAPE AND ROUGHNESS

(71) Applicant: Raydiance, Inc., Petaluma, CA (US)

(72) Inventors: Ramanujapuram A. Srinivas, Santa Clara, CA (US); David M. Gaudiosi, Santa Rosa, CA (US); Michael R. Greenberg, Santa Rosa, CA (US); Jeffrey Albelo, Portland, OR (US); Tim Booth, Penngrove, CA (US); Michael Shirk, Brentwood, CA (US); Michael Mielke, Santa Rosa, CA (US)

(73) Assignee: Raydiance, Inc., Petaluma, CA (US)

(21) Appl. No.: 13/954,136

(22) Filed: Jul. 30, 2013

Related U.S. Application Data
(60) Provisional application No. 61/677,372, filed on Jul. 30, 2012.

(51) Int. Cl. B29C 59/16

(52) U.S. Cl. CPC B29C 59/16
USPC 264/400; 425/174.4

(57) ABSTRACT

The method of and device for cutting brittle materials with tailored edge shape and roughness are disclosed. The methods can include directing one or more tools to a portion of brittle material causing separation of the material into two or more portions, where the as-cut edge has a predetermined and controllable geometric shape and/or surface morphology. The one or more tools can comprise energy (e.g., a femtosecond laser beam or acoustic beam) delivered to the material without making a physical contact.

### CROSS-REFERENCE TO RELATED APPLICATION(S)

This application claims priority under 35 U.S.C. §119(e) of the U.S. Provisional Patent Application Ser. No. 61/677,372, filed Jul. 30, 2012 and titled, “CUTTING OF BRITTLE MATERIALS WITH TAILORED EDGE SHAPE AND ROUGHNESS,” which is hereby incorporated by reference in its entirety for all purposes.

### FIELD OF THE INVENTION

The present invention relates to material processing. More specifically, the present invention relates to systems for and methods of cutting brittle materials.

### BACKGROUND OF THE INVENTION

Cutting is a material separation process that often involves the application of chemical processes and/or mechanical forces to materials, particularly brittle materials, such as glass, sapphire, or silicon. Other common examples of materials that are often processed to create products via cutting include, but are not limited to, amorphous solid materials, crystalline materials, semiconducting materials, crystalline ceramics, polymers, resins, and so forth.

Typical techniques for cutting brittle materials include mechanical saw processes, scribe and break, direct laser machining, laser thermal shock cleaving, or a combination of mechanical and laser steps. Although the net results of these techniques are somewhat different from one another, they all share the drawback of insufficient control of the as-cut edge properties.

Brittle materials are used in multiple commercial markets for consumer, industrial and medical goods. There are aspects to be taken into consideration when processing and manufacturing products with brittle materials.

In the aspect of speed of cutting/processing a brittle material, there are multiple figures of merit (FOM) used in commercial markets for quantifying the effective cutting speed for brittle materials. For example, the linear cutting speed can be calculated by dividing the total length of material cut by the total cutting time to yield an effective cutting speed with measurement units of meters per second (m/s). Depending upon the exact material species, material thickness and desired edge characteristics, the effective cutting speed can be more appropriately compared in units of millimeters per second (mm/s).

Another example of an FOM for quantifying the effective cutting speed for brittle materials is the Takt time, or cycle time, that is required to produce a unit of the cut-out portion of brittle material from an initial substrate of brittle material. The Takt time for a production line is often characterized by number of seconds, or minutes, required to produce a unit. The Takt time calculation can include the linear cutting speed as a variable. The Takt time can also include additional steps required to produce the finished unit as variables in the calculation, such as grinding, polishing, etching, annealing, chemical bath, or ion-exchange treatment.

In the material property aspect, brittle materials can be characterized by the lack of plastic deformation prior to breaking when a stress is applied to the material. When subjected to stress, a brittle material breaks without significant deformation (strain). This property is not exclusive of strength, since some brittle materials can be very strong, such as diamond, sapphire or strengthened glass.

In the manufacturing aspect, brittle materials can be especially challenging to cut, drill or mill, with controlled edge properties since these materials tend to chip and/or crack using typical methods. These defects are usually the result of “brittle fracture,” which are cracks that propagate through a stressed material along paths of least resistance. The intrinsic microscopic stress anisotropy of brittle materials, and/or the randomized local stress applied by traditional cutting tools, imposes uncontrolled edge shape and/or surface morphology on the as-cut edge. This uncontrolled edge quality can result from cracks running along transgranular pathways in the brittle material tracing the lattice orientation within each microscopic grain element in the material. Similarly, the uncontrolled edge quality can result from cracks running along intergranular pathways in the brittle material traversing the grain boundaries between individual grain elements in the material. The limitations of controlling the as-cut edge quality of a brittle material with traditional techniques depend upon the grain size in the material and/or the dislocation mobility allowed by the grain structure.

Typical methods of cutting brittle materials fail to control the as-cut edge shape and/or surface morphology since they apply a force (such as mechanical and/or thermal) that often leads to crack propagation along native crystallographic planes of high shear stress of the brittle material. Defects within the bulk of the brittle material substrate can be the result of the crystal growth process, impurities, or the stochastic grain pattern. Similarly, defects at the surface of the brittle material substrate can result from the crystal growth process, impurities, the stochastic grain pattern, or the substrate forming process, e.g., slicing, lapping or machining. The uncontrolled crack propagation common with the typical methods can be caused by the cutting tool. Mechanical cutting tools can have microscopically random shapes, hardnesses, and/or applied force. Thermal cutting tools can create microscopically random heat distributions in the brittle material.

FIG. 1A illustrates a typical method 100 of cutting a stock of brittle material 101 (hereinafter “material” 101) using a typical tool 102 such as a mechanical saw. When the typical tool 102 is applied on the material 101, a cutting/breaking/cracking line 104 is created. A first portion 106 and a second portion 108 are formed by separating the material 101 into two or more pieces. The material 101, such as a brittle material, forms rough edges 110 when the typical tool 102 is applied to cut the material 101.

FIG. 1B illustrates three rough edges 112, 114, and 116 made by using typical methods and devices for cutting a brittle material. The rough edges 112, 114, and 116 have respectively large, medium and small roughness profiles of the brittle material 101 created by application of the typical tool 102. When the size (length in any directions) of the defect 118 is greater than a size of a critical defect, such as equal to or greater than 10-20 microns, the brittle material 101 can crack or become easy to break at a predetermined amount of impact of force.

Although the typical methods of and devices for brittle materials cutting have allowed cutting into predetermined shapes to a certain degree, these typical methods and devices impose uncontrollable edge properties in the resultant cut-outs as shown in FIG. 1B. Multiple-process fabrication protocols are therefore required in the typical process and methods, whereby the cut-out edges are subsequently conditioned to achieve the desired edge properties, which are time consuming and associated with higher manufacturing costs. For example, an electronic display panel comprising thin glass typically exhibits micro-cracks and chips of uncontrolled dimensions along the cut edge(s), and these features are typically removed via multiple steps of fine grit polishing of the edge(s) in the typical methods. Polishing, grinding, lapping, etching, sanding, annealing, and/or chemical bath are part of the subsequent steps for after-cut edge treatment process in the typical methods.

### SUMMARY OF THE INVENTION

According to some embodiments, the present invention is directed toward methods of and systems for material cutting. In some embodiments, the methods and systems include directing one or more tools to a portion of brittle material causing separation of the material into two or more portions, where the as-cut edge has a predetermined and highly controllable geometric shape and/or surface morphology. The one or more tools can comprise energy delivered to the material without making physical contact, for example from a laser beam or acoustic beam.

In some embodiments, the present invention is directed toward devices that cut brittle material. These devices comprise tools, or combinations of tools, for separating a brittle material into two or more portions, where the as-cut edge has a predetermined and highly controllable geometric shape and/or surface morphology. The one or more tools comprise energy delivered to the material without making physical contact, for example from a laser beam or acoustic beam.

In some embodiments, the present invention is directed toward the separate portions of a material created by a process. In some embodiments, the process includes: (a) providing a stock of brittle material and (b) applying one or more tools to a portion of the brittle material causing separation of the material into two or more portions in a way that precisely controls the geometric shape and/or surface morphology of the edge(s) of at least one of the separate portions.

In one exemplary embodiment, the present invention is directed toward methods of and systems for brittle material cutting. The methods and systems include directing one or more laser beams to a portion of the brittle material causing a separation of the material into two or more portions, where at least one of the portion edges created by the laser beam exposure has a predetermined and highly controllable geometric shape and/or surface morphology.

In another exemplary embodiment, the present invention is directed to devices that cut brittle materials. These devices comprise one or more lasers and the laser beam directing mechanisms for exposing a portion of the brittle material to the laser light causing separation of the brittle material into two or more portions, where at least one of the resultant portion edges created by the laser exposure has a predetermined and highly controllable geometric shape and/or surface morphology. It will be appreciated that the laser beam directing mechanisms can include changing the path of the laser beam, changing the location or orientation of the work piece, or all in combination.

In an additional exemplary embodiment, the present invention is directed to the separate portions of a brittle material created by a process. The process includes: (a) providing a stock of brittle material and (b) applying one or more laser beams to a portion of the brittle material causing separation of the material into two or more portions in a way that precisely controls the geometric shape and/or surface morphology of the edge(s) of at least one of the separated portions.

In an aspect, a method of cutting a brittle material comprises cutting the brittle material by applying a laser and forming an edge with a surface having a predetermined edge shape and roughness. In some embodiments, the laser comprises a femtosecond laser. In some embodiments, the femtosecond laser has pulse duration less than 1 picosecond or 0.000000000001 s. In other embodiments, the surface is substantially flat. In some other embodiments, the surface is perpendicular to the body of the brittle material. In some embodiments, the edge comprises an oblique angle between the surface and the body of the brittle material. In other embodiments, the edge comprises a tapered edge. In some embodiments, the edge comprises a curved edge. In other embodiments, the surface comprises chips or cracks having a depth not greater than 50 micrometers. In other embodiments, the surface comprises chips or cracks having a depth not greater than 20 micrometers. In some other embodiments, the chips or cracks comprise a predetermined peak-to-valley depth. In some embodiments, the brittle material comprises an intrinsic material bending strength greater than 200 megapascal (Mpa) after the cutting process. In other embodiments, the brittle material comprises an intrinsic material bending strength greater than 500 megapascal (Mpa) after the cutting process. In some other embodiments, the brittle material comprises a borosilicate glass, a soda-lime glass, quartz, sapphire, silicon, or a combination thereof. In some embodiments, the brittle material comprises a strengthened glass. In other embodiments, the brittle material comprises a tempered glass. In some embodiments, the brittle material retains an intrinsic bending strength after cutting.

In another aspect, a method of cutting a brittle material comprises forming apertures by making a laser-induced breakdown of the brittle material using a first laser beam, forming a shape of a predetermined profile for cutting, and separating a first portion of the brittle material from a second portion of the brittle material by using a second laser beam. In some embodiments, the first laser beam comprises a femtosecond laser beam. In other embodiments, the second laser beam comprises a femtosecond laser beam. In some other embodiments, the second laser beam comprises a continuous wave laser beam. In certain embodiments, both the first laser beam and the second laser beam comprise a femtosecond laser beam. In other embodiments, the second laser beam comprises a wave length longer than the first laser beam. In some embodiments, the method further comprises programming a programmable device to form the predetermined profile. In other embodiments, the method further comprises automatically placing the brittle material to the device. In some other embodiments, the method further comprises automatically removing the brittle material from the device after the using of the second laser beam. In other embodiments, the method further comprises flipping the brittle material. In some other embodiments, the method further comprises combining the brittle material with an electronic device after the separating. In some embodiments, the method further comprises covering an electronic device to form a protective layer. In other embodiments, the brittle material comprises glass, quartz, sapphire, silicon, or a combination thereof. In some other embodiments, the method further comprises forming an edge after the using of the second laser beam. In some embodiments, the edge comprises a substantially flat surface. In other embodiments, the edge comprises an edge with a right angle, a tapered edge, a curved edge, or a combination thereof. In some other embodiments, the edge comprises chips or cracks having a depth not greater than 50 micrometers. In other embodiments, the edge comprises chips or cracks having a depth not greater than 20 micrometers.

In another aspect, a device for cutting a brittle material comprises a femtosecond laser generating device programmed to ablate the brittle material to form a predetermined shape and a substrate holder. In some embodiments, the device further comprises a second laser generating device. In other embodiments, the second laser generating device is programmed to separate the predetermined shape from a remaining portion of the brittle material. In some other embodiments, the second laser generating device comprises a continuous wave laser beam generator. In some embodiments, the second laser generating device generates a laser pulse having a wave length longer than the wave length that is generated by the femtosecond laser. In other embodiments, the substrate holder is configured to hold a brittle material. In some other embodiments, the brittle material comprises a glass. In some embodiments, the predetermined shape comprises a protective cover of an electronic device. In certain embodiments, the predetermined shape comprises an active screen of an electronic device. In other embodiments, the electronic device comprises a mobile phone.

Other features and advantages of the present invention will become apparent after reviewing the detailed description of the embodiments set forth below.

### BRIEF DESCRIPTION OF THE DRAWINGS

Embodiments will now be described by way of examples, with reference to the accompanying drawings which are meant to be exemplary and not limiting. For all figures mentioned herein, like numbered elements refer to like elements throughout.

FIG. 1A illustrates a typical method of cutting a stock of brittle material using a typical tool.

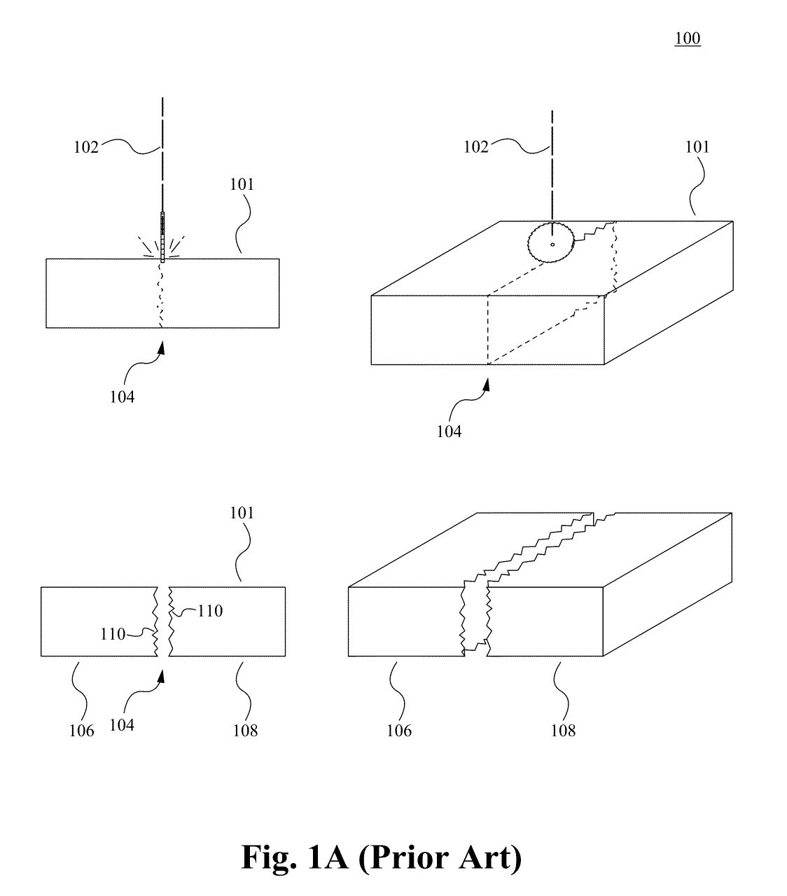

FIG. 1B illustrates three rough edges made by using typical methods of and devices for cutting a brittle material.

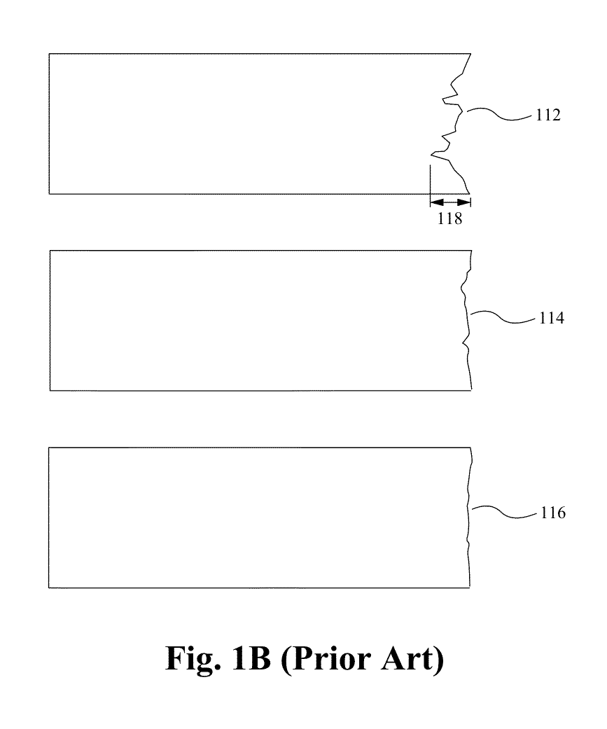

FIG. 2 illustrates an apparatus for applying a tool to a brittle material substrate in accordance with some embodiments of the present invention.

FIG. 3 illustrates a profile view of three edge geometric shapes that are created by applying the tool to a brittle material substrate in accordance with some embodiments of the present invention.

FIG. 4 illustrates a cross sectional view of void patterns on the brittle material made by the methods and devices in accordance with some embodiments of the present invention.

FIG. 5 illustrates a top-down view of a tool path pattern that includes stress relief lines in accordance with some embodiments of the present invention.

FIG. 6 illustrates a top-down view of another tool path pattern that includes stress relief lines in accordance with some embodiments of the present invention.

FIG. 7 illustrates a top-down view of a tool path pattern in accordance with some embodiments of the present invention.

FIG. 8A illustrates a temperature discontinuity separation fixture in accordance with some embodiments of the present invention.

FIG. 8B illustrates the resultant temperature pattern in a brittle material substrate during application of the temperature discontinuity separation fixture in accordance with some embodiments of the present invention.

FIG. 9 illustrates a device for cutting a brittle material in accordance with some embodiments of the present invention.

FIG. 10 is a flow chart illustrating cutting a brittle material method in accordance with some embodiments of the present invention.

FIG. 11 is a flow chart illustrating cutting a brittle material method using a single laser in accordance with some embodiments of the present invention.

### DETAILED DESCRIPTION OF THE PREFERRED EMBODIMENT

Reference is made in detail to the embodiments of the present invention, examples of which are illustrated in the accompanying drawings. While the invention is described in conjunction with the embodiments below, it is understood that they are not intended to limit the invention to these embodiments and examples. On the contrary, the invention is intended to cover alternatives, modifications and equivalents, which can be included within the spirit and scope of the invention as defined by the appended claims. Furthermore, in the following detailed description of the present invention, numerous specific details are set forth in order to more fully illustrate the present invention. However, it is apparent to one of ordinary skill in the prior art having the benefit of this disclosure that the present invention can be practiced without these specific details. In other instances, well-known methods and procedures, components and processes have not been described in detail so as not to unnecessarily obscure aspects of the present invention. It is, of course, appreciated that in the development of any such actual implementation, numerous implementation-specific decisions must be made in order to achieve the developer's specific goals, such as compliance with application and business related constraints, and that these specific goals can vary from one implementation to another and from one developer to another. Moreover, it is appreciated that such a development effort can be complex and time-consuming, but is nevertheless a routine undertaking of engineering for those of ordinary skill in the art having the benefit of this disclosure.

In the following, methods of and devices for cutting brittle materials with a tailored edge shape and roughness are disclosed in accordance with some embodiments of the present invention. The present invention is able to cut brittle materials, such as glass, sapphire or silicon, into precise cut-out shapes while controlling the as-cut edge properties, such as roughness, micro-cracking, taper or bevel, which impact structural and cosmetic characteristics of brittle materials, such as the bending strength and tactile user experience of an electronic display panel.

One of the uses of the present invention is cutting brittle materials with controlled edge quality and within a relatively brief period of time when compared to typical available cutting techniques.

In some embodiments, the present invention enables cutting of brittle materials into predetermined shapes while maintaining a high level of control over the cut edge properties. Hence, the subsequent conditioning processes are able to be reduced or eliminated from the overall fabrication protocol. The present invention can be utilized to create singulated products with greatly varying options for geometrical configurations. Additionally, the systems and methods disclosed herein can be utilized to fabricate features into products with fine precision. Examples of features include slits, apertures, grooves, notches, etching, and so forth.

In some embodiments of the present invention, the methods are able to substantially reduce the Takt time by reducing or eliminating some or all of the additional steps for making the required edge shape and/or surface morphology.

In some embodiments of the present invention, the methods and devices are able to prevent uncontrolled crack propagation by pre-defining the crack propagation pathway by modification of the intrinsic brittle material stresses or defects, or by insertion of artificial stresses or defects, which guide the crack propagation. The modification mechanisms can include some or all of changes to the local lattice structure in order to create localized stress planes, discontinuous density of the material, and/or a variation of the energy absorption properties.

In some embodiments of the present invention, the methods and devices are able to prevent uncontrolled crack propagation by applying the cutting tool in a pattern that compensates for the intrinsic granular pathways. The pattern can include localized adjustment of energy delivered from the tool to the brittle material, localized translation of the tool to compensate intrinsic granularity of the brittle material, and/or selective placement of energy from the tool to the brittle material, such as with pulsing a beam of directed energy.

In some embodiments of the present invention, the methods and devices are able to produce as-cut edge geometric shape and/or surface morphology that satisfy the shape and morphology requirements of a finished product or finished component of a finished product.

In some embodiments, the present invention is applied to cutting thin panels of brittle material (e.g. glass or sapphire) for utilization in electronic displays.

In some embodiments, the present invention is used to fabricate a portion of the brittle material having functional surface properties, such as for controlling the optical properties of the surface, the tactile properties of the surface and/or the chemical reactivity of the surface. Creating the functional properties for the as-cut brittle material surface comprises imparting a periodic structure with periodicity on the scale of nanometers, micrometers, or larger. The periodic structure can be a superposition of multiple substructures, such as combining nanometer scale structures on top of micrometer scale structures.

In some embodiments, the methods of the present invention forms the functional surface properties of a brittle material, which enhance the cosmetic appearance and enhance the structural integrity of the resultant brittle material portion, especially when the brittle material portion is combined with other materials into a finished product, such as a handheld consumer electronic device.

In some embodiments, the present invention changes/manipulates/controls the optical properties of the as-cut surface. The optical properties include reflecting, transmitting, diffracting, and/or scattering properties of light by the surface. By changing these optical properties, the methods of the present invention can impart a substantially different visual performance of the as-cut surface. The visual performance of the as-cut surface can be modified to be brighter or darker, shiny or dull, and/or having a color (hue) change, as compared to the native brittle material surface. The controlled optical properties of the as-cut surface exhibit different optical response depending on the viewing angle of the surface.

In some embodiments, the present invention controls the tactile properties of the as-cut surface, including manipulating the coefficients of friction of the surface and/or adding a contour to the surface. By changing these tactile properties, the present invention can impart a surface quality that feels smooth to the human touch, thereby making the as-cut portion of the brittle material more pleasing to hold in the user's hand and/or be carried close to the body, such as in an arm-band mounted holster. The enhanced tactile properties of the as-cut brittle material portion can be discernable for the portion in mechanical isolation and/or once the portion is assembled with other materials into finished product, such as a handheld consumer electronic device. By changing the tactile properties of the as-cut brittle material surface, the present invention can impart a surface quality that makes the resultant device easier to grip.

The brittle material disclosed herein can include one or more of the following types of materials: glass, sapphire, single crystal or monocrystalline, polycrystalline, ceramic, tungstate, oxide, alloy, hybrid metal/non-metal composite, or a combination of any of these. Further, the brittle material disclosed herein can include a doped, tinted, or color-modified version of the above materials. Furthermore, the brittle material disclosed herein can include a tempered or strengthened glass with an engineered stress profile. The brittle material can comprise Gorilla® or Eagle glass (e.g., Eagle XG®) from Corning® or Dragontrail® from Asahi Glass Co. Ltd. The brittle material can also include one of these types of glass that is cut with the method of the present invention prior to the tempering or strengthening process step. The tempering or strengthening process step can comprise heating the glass or subjecting the glass to an ion exchange treatment. The brittle material can be one of these types of glass that is cut with one of the methods of the present invention subsequent to the tempering or strengthening process step.

Moreover, the present invention is able to cut brittle materials that have inclusions, stress planes, discontinuities, or other intrinsic properties that are unable to be cut by a typical methods and devices (e.g., diamond saw). The present invention has many advantageous features over typical cutting processes. The edges of the brittle material that is cut using the present invention has smoother as-cut surface compared with the surface that is cut using typical methods, which can be quantified and measured by measuring the size of surface micro-cracks, spallation, and/or chips. The brittle material that is cut using the embodiments of the present invention has stronger bending strength when compared with the brittle material that is cut using a typical method.

In some embodiments, the present invention is used to fabricate portions of brittle materials to be integrated into consumer electronic devices, such as smart phones, tablet computers, personal digital assistants, laptop or notebook computers, desktop computer monitors, television sets, portable music players, computer mouse, touch-sensitive motion controllers, and protective covers for any of these electronic devices. In some embodiments, the portions of brittle materials to be integrated into consumer electronic devices include display screens, touch screens, multi-touch screens, display back planes, display illumination layers, light emitting diode (LED) substrates, and/or transparent conducting layers.

In some embodiments, the present invention is used to fabricate portions of brittle materials into cut-outs, substrates from which additional portions will be cut, cut-outs with feature portions removed from within the cut-out perimeter, and/or cut-outs having multiple macroscopic functions enabled within the brittle material common plane. The feature portions and enabled functions can comprise visual displays, acoustic transfer channels, photographic recording portals, sound recording portals, mechanical buttons, mechanical switches, ambient light sensors, photographic flash emitters, antennas, electronic connectors, fiber optic connectors, touch screen buttons, touch screen switches, mechanical clips, corporate logo markings, cosmetic designs, fluid transfer channels, radio frequency wave transmission channels, and/or thermal transducers.

In some embodiments, the present invention is used to cut brittle materials with a thickness (the dimension is defined by a plane substantially parallel to the direction of tool application)<500 micrometers while controlling the as-cut edge properties. Cutting thin sheets of brittle materials into separate portions is generally very difficult since typical methods impose collateral damage in the form of large cracks, spallation, chips or internal faults. In some embodiments, the present invention is used to cut brittle materials with thickness<300 micrometers while controlling the as-cut edge properties.

In some embodiments, the system of the present invention includes a cutting tool, tool delivery components, cutting method software, computer-readable instructions, or templates stored/retained in the machine memory, brittle material handling devices, electronics to control system functionality and/or monitor system performance, software to control system functionality, monitor system performance and/or provide telemetry of system operations, and/or system performance validation metrology.

In some embodiments, the system of the present invention includes the tool(s) that enable separating a portion of a brittle material from a first larger portion of the material, removing smaller sections of brittle material from within the perimeter of the smaller portion, and modifying the edges to create chamfer, beveling, rounding or squaring of the as-cut edge.

In some embodiments, the as-cut edge quality of the brittle material using the methods and device of the present invention has the following features: (1) the size of the micro-cracks on the as-cut edge is smaller than about 15 micrometers or penetrates less than about 15 micrometers into the bulk of the material; (2) the sizes of the chips, spall or burrs on the as-cut edge are smaller than 20 micrometers or penetrate less than about 15 micrometers into the bulk of the material; (3) the surface of the as-cut edge is smooth to the touch of a human finger; (4) the as-cut edge has cut edge root-mean-square (RMS) roughness less than about 15 micrometers (In some embodiments, the as-cut edge has cut edge RMS roughness less than about 2 micrometers); (5) the as-cut edge has roughness designed to minimize light loss due to scattering; (6) the as-cut edge has shapes of beveled, or chamfered, sidewalls; (7) the as-cut edge has tapered sidewalls; (8) the as-cut edge enables the cut-out to sustain bend strength of greater than about 60 megapascal (MPa) after cutting, as measured using a three-point, or four-point, flexural strength test; (9) the brittle material with the as-cut edge enables the cut-out to sustain bend strength of greater than about 400 MPa after cutting and post-cut strengthening, as measured by a three-point, or four-point, flexural strength test; and (10) the brittle material with the as-cut edge exhibits a polarized light-measured stress field less than about 50 micrometers deep into the material. The properties are listed as exemplary features. A person of ordinary skill in the art appreciates that other features are within the scope of the present invention.

The system of the present invention can implement a cutting pattern with an arbitrary tool path, e.g. with curves, straight-lines, sharp corners, oblique corners or independent arbitrary cut-out features. The cutting pattern can be continuous or discontinuous when tracing the arbitrary tool path. The cutting pattern can traverse a tool path inside or outside the perimeter of a previous tool path. The cutting pattern(s) can be programmable via software or external machine commands.

In some embodiments, the present invention uses a tool comprising selectively variable output from a femtosecond laser source as part of the cutting process. In some embodiments, the present invention uses a tool comprising burst mode output from a femtosecond laser, where the individual femtosecond laser pulses are grouped into short bursts lasting 10 to 1000 nanoseconds and the time interval between individual pulses is about 1 to 100 nanoseconds. In some embodiments, the present invention uses shaped bursts of femtosecond laser pulses in a burst mode format, where the amplitude of each individual pulse within the overall burst has a unique value. In some embodiments, the present invention uses temporally shaped pulses on the femtosecond to picosecond time scale. In some embodiments, the present invention uses tools comprising a dual light source (e.g., a femtosecond laser and a longer pulse or a continuous wave (CW laser)). In some embodiments, the present invention uses tools comprising a femtosecond laser and an acoustic transducer.

In some embodiments, the method of the present invention comprises providing a stock of brittle material to be cut, directing a first source of energy to the brittle material along a programmed tool path in order to impart a microscopic defect zone, and directing a second source of energy to the brittle material, following a substantially identical tool path as the first source of energy, or at least a portion of that path, in order to cause a controlled separation of the original portion of brittle material into two new portions of brittle material, where the as-cut edge quality of the one or more new portions has predetermined and highly controllable geometric shape and/or surface morphology.

In the following description, devices for and methods of cutting of brittle materials with tailored edge shape and roughness are disclosed in further detail in accordance with some embodiments of the present invention.

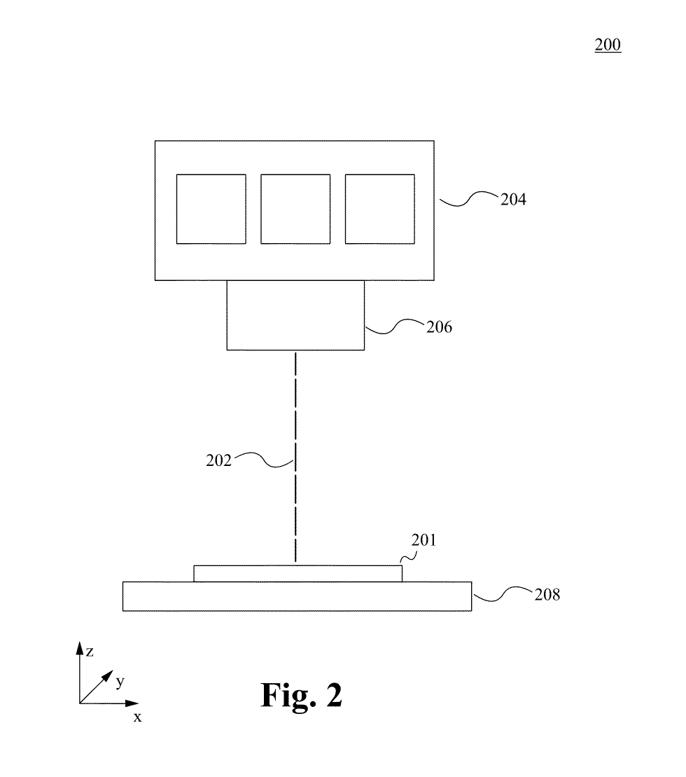

FIG. 2 illustrates an apparatus 200 for applying a tool 202 to a brittle material substrate 201 in accordance with some embodiments of the present invention. The tool is generated by a source 204 and directed to the substrate 201 by a delivery module 206. The substrate is positioned by a fixture 208.

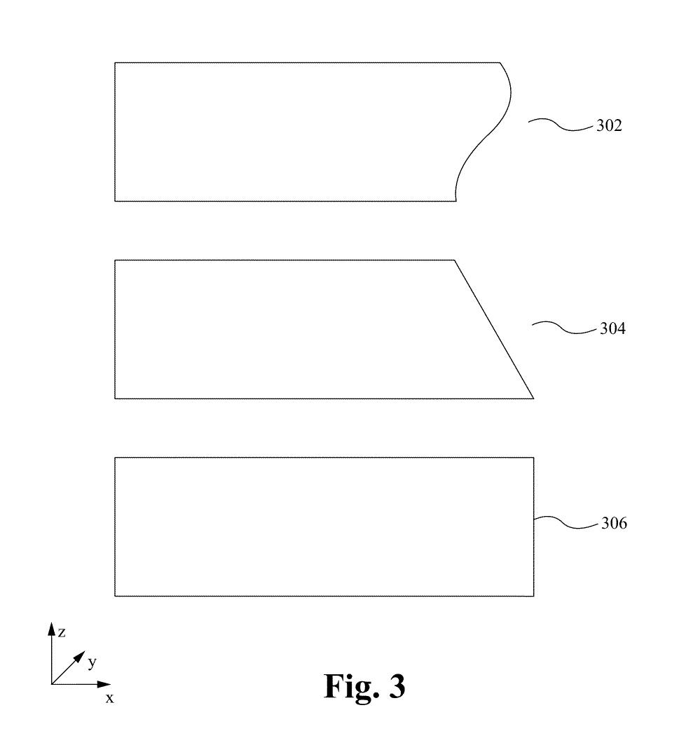

FIG. 3 illustrates a profile view of three edge geometric shapes that are formed by applying the tool 202 to a brittle material substrate 201 in accordance with some embodiments of the present invention. Shape 302 is an arbitrary curved contour with inflection points. Shape 304 is a uniform taper with an exemplary precise taper angle. Shape 306 is a zero-taper edge. The zero-taper edge is perpendicular to the brittle material 201 top and/or bottom edges. A person of ordinary skill in the art appreciates that any other shapes are able to be formed using the methods and devices of the present invention, such as rounded curve and triangle with a sharp edge.

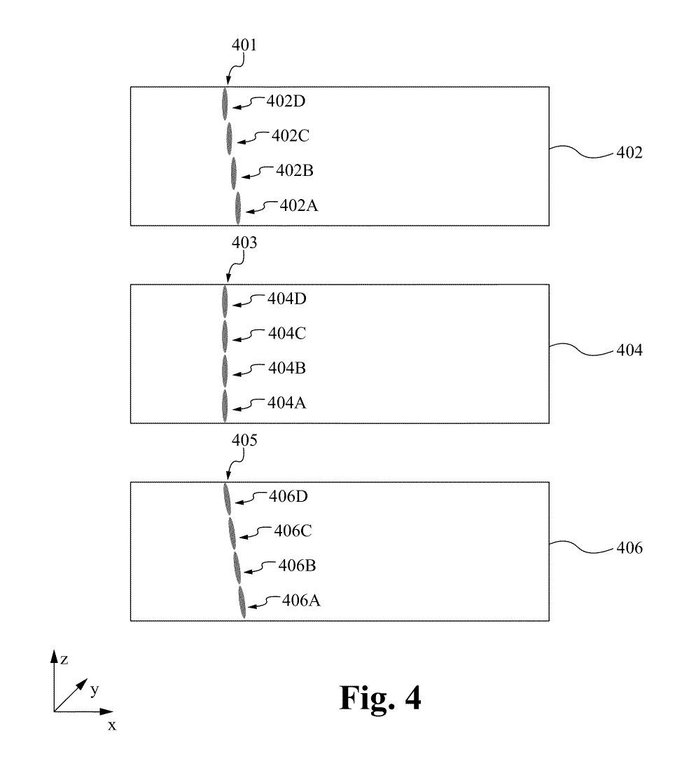

FIG. 4 illustrates a cross sectional side view of void patterns on the brittle material made by the methods and devices in accordance with some embodiments of the present invention. In some embodiments, a first source of energy, such as a femtosecond pulse laser beam, forms a series of void patterns 401, 403, and 405 via a laser induced breakdown. In the first brittle material 402, the void pattern has the defect zones 401 with individual voids 402A, 402B, 402C, and 402D that are stacked vertically with stair-step lateral offset from one void to the next. In some embodiments, a first femtosecond pulse laser beam makes a void 402A via a laser induced breakdown on the brittle material near the bottom side of the brittle material. Next, a second femtosecond pulse laser beam makes a void 402B via a laser induced breakdown on the brittle material. A third and fourth femtosecond pulse laser beams make voids 402C and 402D via a laser induced breakdown on the brittle material. The voids 402A to 402D are able to be created in any orders. For example, a first femtosecond pulse laser beam creates void 402D. A second femtosecond pulse laser beam creates void 402C. A third femtosecond pulse laser beam creates void 402B. Similarly in some other embodiments, a first femtosecond pulse laser beam creates the void 402B and a second femtosecond pulse laser beam creates the void 402D.

In the second brittle material 404, the void pattern has the defect zones 403, which has individual voids 404A-404D that are stacked vertically with no lateral offset from one void to the next. In the third brittle material 406, the void pattern contains the defect zones 405, which has individual voids 406A-406D that are stacked diagonally with no lateral offset from one void to the next with respect to the oblique diagonal. In some embodiments, some portions of the voids are overlapping from one void to the next. A person of ordinary skill in the art appreciates that the voids are able to be created in any angles, any sequences, any shapes and any patterns.

Exemplary methods of and devices for cutting brittle materials are disclosed in accordance with some embodiments of the present invention.

In some embodiments, a method of cutting a brittle material comprises providing a stock of brittle material to be cut, directing a first laser beam to the brittle material along a programmed tool path in order to impart a microscopic defect zone, directing a second laser beam to the brittle material following a substantially identical or identical tool path of the first laser beam, and causing a controlled separation of the original portion of brittle material into two new portions of brittle material. In some embodiments, the second laser beam generates void pattern overlapping at least a portion of the void pattern generated by the first last beam. Using the method of the present invention, the as-cut edge quality of the one or more new portions has predetermined geometric shape and/or surface morphology.

In some embodiments, a method of cutting a brittle material comprises providing a stock of brittle material to be cut, directing a first femtosecond pulse laser beam to the brittle material along a programmed tool path in order to impart a microscopic defect zone, directing a second long pulse or CW laser beam (a continuous wave laser beam) to the brittle material following a substantially identical tool path as the first laser beam or at least a portion of that path, and causing a controlled separation of the brittle material into two new portions of brittle material. The as-cut edge quality of the one or more new portions has predetermined controllable geometric shape and/or surface morphology.

The tool path followed by the first laser beam in this exemplary embodiment includes a pattern that traces the outline of the desired as-cut device along with well-defined stress relief pathways, or lines. The stress relief lines are positioned using the first laser beam at predetermined locations adjacent to the device outline portion of the pattern to facilitate the propagation of a separation line along the device outline. These stress relief lines are particularly useful when propagating a separation line around a small radius feature, such as the corner of a display panel, where the intrinsic stress of the brittle material substrate tends to create uncontrolled pathways for material separation.

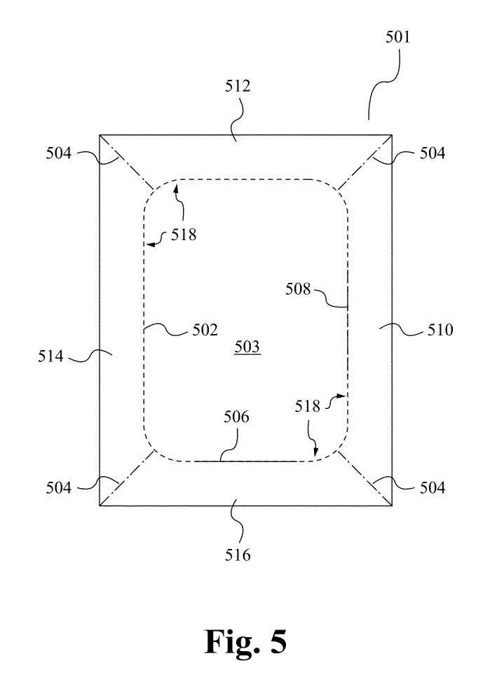

FIG. 5 illustrates a top-down view of a tool path pattern 502 that includes stress relief lines 504 in accordance with some embodiments of the present invention. The brittle material 501 is first exposed to the first laser beam that first follows the device outline tool path 502, then follows the stress relief tool path 504. In some embodiments, the tool path 502 is a continuous line 506. In alternative embodiments, the tool path 502 constitutes spatially cut points/voids 508 remote from each other.

In some embodiments after the first laser beam has traced out the full pattern to define the preferred stress fracture pathways 504, the brittle material 501 is then exposed to the second laser beam that follows the device outline tool path 502. Under exposure to the second laser beam, the brittle material 501 separates into at least five new portions comprising the new brittle material device portion 503 along with four sacrificial portions 510, 512, 514, and 516. The as-cut edge quality of the device portion 503 has predetermined and highly controllable geometric shape and/or surface morphology.

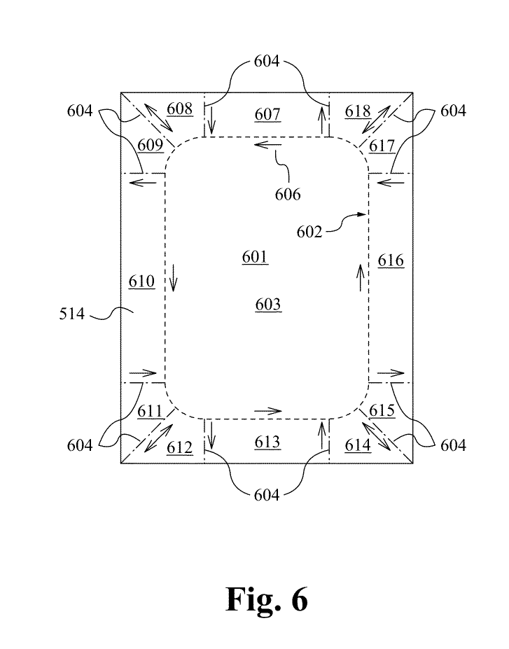

FIG. 6 illustrates a top-down view of another tool path pattern 602 that includes stress relief lines 604 in accordance with some embodiments of the present invention. A first laser beam, such as a femtosecond pulse laser beam, is applied on a brittle material 601 following a device outline tool path pattern 602 in a direction indicated by the arrow 606. Next, the first laser beam is applied to the stress relief lines 604. The arrows 606 show the directionality of the first laser beam tool path. Next, a second laser beam, such as a second long pulse (e.g., a picosecond laser beam) or a CW laser beam, is applied on the brittle material 601 following only the device outline of the tool path 602. In some embodiments, the picosecond laser used has pulse duration longer than 1 ps (picosecond) and less than 1 ns (nanosecond). In some embodiments, the second long pulse used has a wavelength longer than the pulse of the first laser beam. After the application of the second laser beam, the brittle material 601 separates into multiple new portions comprising the new brittle material device portion 603 along with multiple sacrificial portions 607-617, where the as-cut edge quality of the device portion 603 has predetermined and highly controllable geometric shape and/or surface morphology.

In some embodiments, the method includes removing a portion of the brittle material from within/surrounded by a larger portion of the brittle material. The tool path followed by the first laser beam comprises a pattern that traces the outline of the interior portion to be removed from a larger portion of brittle material along with well-defined stress relief pathways or lines. The stress relief lines are positioned using the first laser beam at a predetermined locations adjacent to, and/or interior to, the outline portion of the pattern to facilitate the propagation of a separation line along the outline. These stress relief lines are important when propagating a separation line inside a small radius feature, such as the interior corner of a display panel feature, where the intrinsic stress of the brittle material substrate tends to create uncontrolled pathways for material separation.

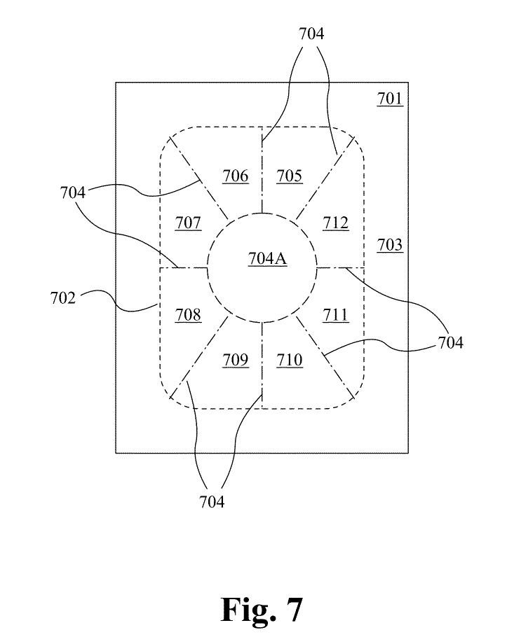

FIG. 7 illustrates a top-down view of a tool path pattern in accordance with some embodiments of the present invention. The tool path pattern includes stress relief lines 704 and 704A interior to the outline portion 702 of the pattern. The brittle material 701 is first exposed to the first laser beam that first follows the outline tool path 702, then follows the stress relief tool path 704 and 704A. These tool paths can be continuous, or they can be spatially remote from each other. After the first laser beam traced out the full pattern to define the predetermined stress fracture pathways, the brittle material 701 is then exposed to the second laser beam that preferably follows only the device outline tool path 702. After the application of the second laser beam, the brittle material 701 is separated into multiple new portions comprising the new brittle material device portion 703 along with sacrificial portions 704-711 (including 704A), where the as-cut edge quality of the device portion 703 has predetermined and highly controllable geometric shape and/or surface morphology.

In some embodiments, applying the first laser beam to the outline tool path 702 and the stress relief tool path 704 is preceded by creation of a “pilot hole” 704A inside the interior of the outline 702 and stress relief lines 704, to facilitate a cleaner separation of the sacrificial portions of brittle material from the larger portion of brittle material. A person of ordinary skill in the art appreciates that the patterns 703-712 can be created in any orders.

In some embodiments, the first and/or second laser beams are focused to a predetermined plane within the brittle material substrate or on the surface of the brittle material in order to selectively expose that plane of the brittle material. The selective exposure can be achieved by using a high-numerical-aperture (high-NA) lens to form a rapidly converging beam. In some embodiments, the numerical aperture (NA) of the lens is greater than 0.1. In other embodiments, the numerical aperture (NA) of the lens is greater than 0.3. In some other embodiments, the numerical aperture (NA) of the lens may be greater than 0.5. In some embodiments, the numerical aperture (NA) of the lens may be greater than 0.7.

In some embodiments, the first and/or second laser beams are shaped by one or more beam shaping optical elements to provide a predetermined laser beam wave front at a specific plane of exposure within the brittle material substrate, or on the surface of the brittle material. For example, the first laser beam wave front can be optimized to provide an extended profile stress defect inside the brittle material. This can be achieved by adding a transparent plate between the high-NA lens and the brittle material substrate to deliberately impose spherical aberration into the laser beam path. This form of beam shaping enables a longer effective depth of focus, thereby creating a stress defect with an extended longitudinal dimension.

In some embodiments, the tool path followed by the first laser beam is repeated two or more times, with a change in focal plane for each iteration of the tool path. The change in focal plane with each iteration can be utilized to form a stacked array of voids, such as those shown in FIG. 4 as mentioned above. Each void layer in the vertical stack is formed within one focal plane. Each focal plane can contain a large number of individual voids placed side-by-side to follow the pattern defined as the brittle material portion outline 702, stress relief lines 704, or pilot hole 704 of FIG. 7. In some embodiments, each focal plane iteration of the tool path is able to be laterally shifted, by a microscopic amount, such that a stair-case defect zone 401 of FIG. 4 is able to be formed. In other embodiments, each focal plane iteration of the tool path is able to have zero lateral shift, such that an inline vertical defect zone 403 of FIG. 4 is able to be formed. In some other embodiments, each focal plane iteration of the tool path can be offset, but following along a diagonal plane, such that a tilted inline defect zone 405 of FIG. 4 is able to be formed.

In some embodiments, the change in focal plane is provided by an active spatial beam phase filter for the laser beam. The phase filter comprises a two-dimensional (2D) liquid crystal spatial light modulator or a 2D deformable mirror assembly. The phase filter is programmable via computer control in order to adjust the focal plane with minimal delay between iterations of traversing the repeated tool path in the brittle material.

The active spatial beam phase filter is able to be programmed to impart a spatial phase to the laser beam that is not purely quadratic. Instead, the phase filter is able to be programmed to mimic the high-NA-lens-plus-transparent-plate wave front optimization scheme, or an alternative wave front optimization scheme that extends the longitudinal dimension of the resultant stress defect. The optimization scheme can be adaptive to self-correct the imposed spatial filter function based on the feedbacks from a laser material process monitoring sensor.

In some embodiments, the methods include removing a portion of the as-cut brittle material within a larger portion of the as-cut brittle material. This method comprises adjusting the temperatures of the as-cut portions of brittle material in order to create a temperature discontinuity between the two portions. In some embodiments, an inner portion of brittle material is cooled, or chilled, to induce thermal material contraction, while the outer material is held at constant temperature, or even heated. The material contraction of the inner portion of brittle material can result in clean separation of the inner and outer portions, so that the separation can occur with minimal resistance from friction, or other surface forces, between the two portions.

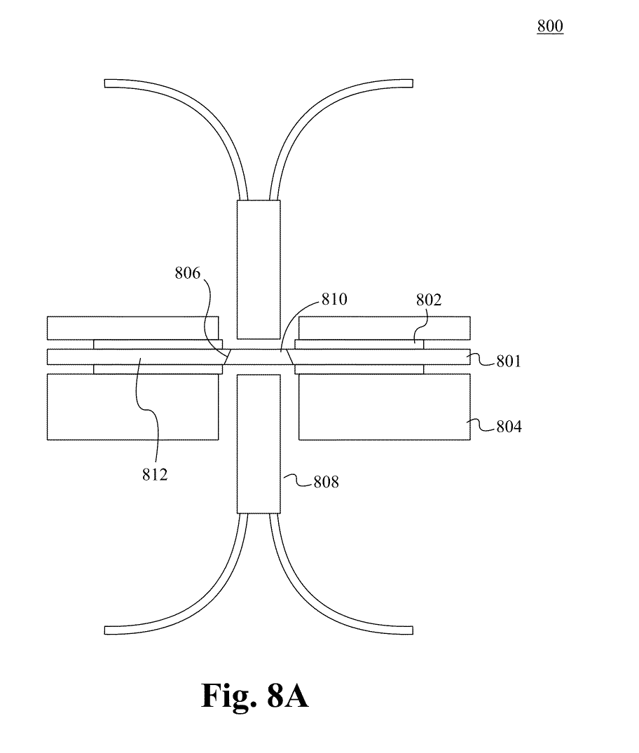

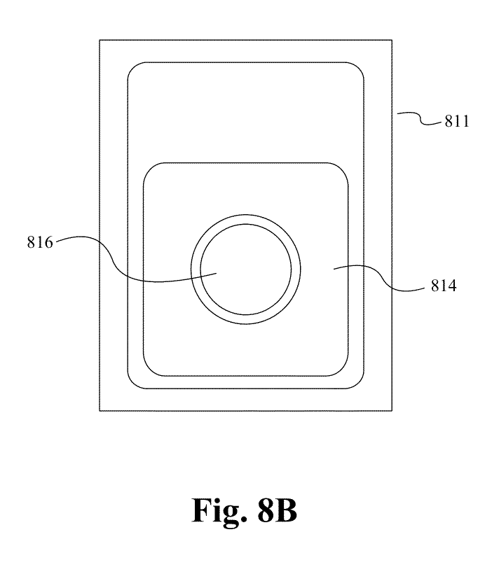

FIG. 8A illustrates a temperature discontinuity separation fixture 800 in accordance with some embodiments of the present invention. The outer portion of the as-cut brittle material 801 is heated, or held at ambient temperature, by heaters 802 held against the brittle material 801 with clamps 804. The inner portion 810 of brittle material 801, which is inside the portion-dividing pattern 806, is rapidly cooled by a cooling tool 808, such as a copper post that is chilled by liquid nitrogen. The rapid cooling of the inner portion 810 causes a mechanical contraction of the inner brittle material portion 810, whereby the inner brittle material portion 810 separates cleanly from the outer portion 812 of brittle material with minimal resistance from friction, or other surface forces, between the two portions.

FIG. 8B illustrates the resultant temperature pattern in a brittle material substrate 811 during application of the temperature discontinuity separation fixture 800 of FIG. 8A in accordance with some embodiments of the present invention. The outer portion of the temperature pattern 814 is held at ambient temperature. In some other embodiments, the temperature pattern 814 is heated above an ambient temperature. The inner portion of the temperature pattern 816 is cooled substantially below the temperature of the outer portion in order to induce separation of the two portions by way of mechanical/physical contraction of the inner portion 816.

In some embodiments, the temperature discontinuity separation step can be executed after the brittle material substrate 811 is exposed to a single laser beam that creates stress defects within the brittle material. The stress defects created by the laser beam provide a pathway for releasing the stress imposed by the temperature discontinuity. This arrangement enables the simultaneous division of a brittle material substrate into two or more portions of brittle material and the separation of the portions while avoiding resistance from friction, or other surface forces, between the resultant portions.

In some embodiments, the temperature discontinuity separation step is executed after the brittle material substrate is exposed to a first femtosecond laser beam that creates stress defects within the brittle material and a second continuous wave, or longer pulse, laser beam that divides the original brittle material substrate 811 into two or more new portions of brittle material. In some embodiments, the division into two or more distinct new portions of brittle material, due to the second laser exposure, does not include the separation of the portions from each other, because of the strong friction, or other surface forces, among the new portions. In these embodiments, the temperature discontinuity separation step is able to be executed after exposure of the brittle material substrate to the second laser beam in order to separate the new portions of brittle material from each other.

In some embodiments, the method comprises providing a stock of a brittle material to be cut, directing a first source of energy tool to the brittle material along a programmed tool to impart a microscopic defect zone, directing a second source of energy tool to the brittle material, following a partially identical tool path as the first source of energy tool to cause a controlled separation of the original portion of brittle material into multiple new portions of brittle material, and directing a third source of energy tool to at least one edge of one of the separated portions to further modify the edge geometry and/or surface morphology, where the as-cut edge quality of the one or more new portions has predetermined and controllable geometric shape and/or surface morphology.

In some embodiments, the third source of energy tool is used to form a chamfer along the perimeter(s) of one of the new portions of brittle material. The perimeter of the brittle material comprises either, or both, an interior or exterior perimeter of the cut-out pattern. The chamfer geometry imparted to the perimeter(s) of the brittle material portion can further improve the functional characteristics of the new portion of brittle material, such as the bending strength of the brittle material portion as evaluated using a multi-point flexural strength test.

In some embodiments, the first, second and/or third source of energy tools comprise femtosecond pulse laser beams. In some embodiments, the first, second and/or third source of energy tools comprise continuous wave (CW) laser beams, such as from a carbon dioxide (CO₂) laser source.

In some embodiments, the third source of energy tool application to the brittle material is preceded by bonding a sacrificial substrate to a portion of the perimeter(s) edge in order to enhance the localized mechanical stress of a portion of the perimeter(s) edge.

In some embodiments, the third source of energy tool application to the brittle material is followed by a thermal shock step to create the desired/predetermined perimeter edge profile, such as the chamfer profile. The thermal shock step can comprise placement of the brittle material, or a perimeter section of the brittle material, in a bath of hot fluid. The hot fluid bath can impart functional features to the brittle material portion, such as an increased bending strength, as a result of an ion-exchange process between the brittle material and the fluid.

In some embodiments, the third source of energy tool is used to create a temporary, thin melt zone along the perimeter(s) of one of the new portions of brittle material. The perimeter of the brittle material comprises either, or both, an interior or exterior perimeter of the cut-out pattern. The thin melt zone is temporary and is followed immediately by a re-solidification. The sequence of melt-and-solidify results in a self-healing effect in the brittle material whereby micro-cracks and/or other defects are filled-in or otherwise erased from the perimeter of the material. The self-healing effect imparted to the perimeter(s) of the brittle material portion improves the functional characteristics of the new portion of brittle material, such as the bending strength of the brittle material portion, which is verified by using a multi-point flexural strength test.

In some embodiments, the thin melt zone creation step is induced by a heat source, such as a torch, a laser, a specifically shaped resistive heating element, or a pair of arc electrodes. The heat source is utilized to heat a thin layer of the perimeter of the brittle material to right above the melt temperature of the brittle material, such as 0.1° C. The application of the heat source is precisely controlled so as to only melt a very thin region nearest the edge of the brittle material. This heat treatment can induce a reflow of molten brittle material to fill-in any discrete defects in the edge profile to create a substantially smoother profile. The macroscopic properties of a brittle material, such as flexural bending strength, can be related to the brittle material edge quality, in terms of geometry and/or surface roughness. Hence, the reflow of the brittle material produced by the application of a heat source can substantially improve the macroscopic performance of the brittle material portion.

In some embodiments, the temperature of the brittle material is entirely raised to a temperature near the softening temperature, or to the melting temperature, intrinsic to the brittle material before, during, and/or after the application of a heat source for improving the edge profile. By elevating the temperature of the entire brittle material near the softening temperature and then applying the heat treatment to the edge of the brittle material portion, the process avoids thermal shock around the perimeter of the brittle material, which causes deleterious side effects.

In some embodiments, a heat source is applied to the perimeter of the as-cut brittle material in order to remove a thin strip of the brittle material, thereby removing a sharp edge and creating a chamfer-like geometry. This effect can be manifested as an evaporation of the brittle material comprising the sharp edge, or as a pealing of the thin strip of brittle material away from the brittle portion, by way of localized thermal stress, that is intended to be transferred onto further usage. Removal of the sharp edge in this embodiment has the macroscopic effect of improving the performance of the brittle material portion in terms of transmitting light, creating optical images, and mechanically strengthening the brittle material portion. The device that integrates the brittle material portion with the treatments described above can improve the cosmetic nature of the brittle material.

In some embodiments, the thin strip removal step is induced by a heat source, such as a torch, a laser, a specifically shaped resistive heating element, or a pair of arc electrodes. The heat source is utilized to remove a thin layer of the perimeter of the brittle material to be just above the melt temperature of the brittle material, such as 0.1° C. The application of the heat source is precisely controlled so as to only strip away a very thin region nearest the edge of the brittle material. The macroscopic properties of a brittle material, such as flexural bending strength, are directly related to the brittle material edge quality, in terms of geometry and/or surface roughness. Hence, the removal of a thin strip from the brittle material produced by the application of a heat source can substantially improve the macroscopic performance of the brittle material portion.

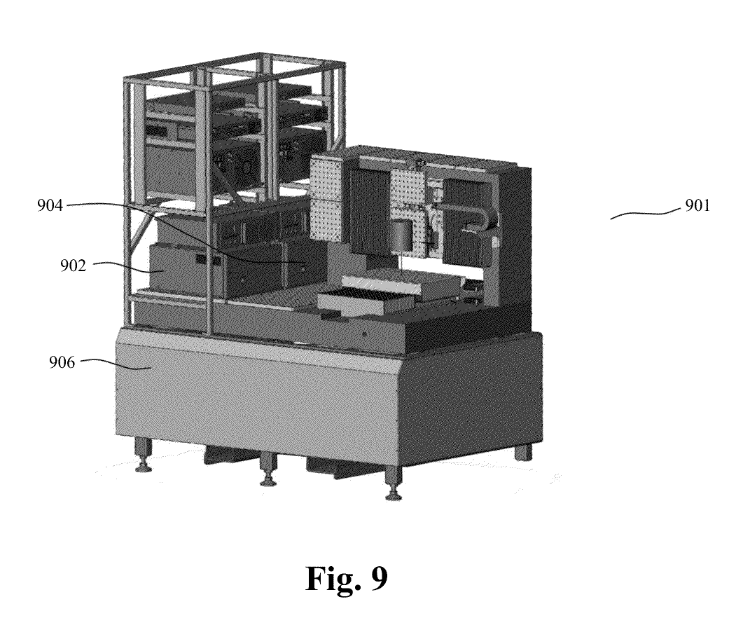

FIG. 9 illustrates a device for cutting a brittle material in accordance with some embodiments of the present invention. The device includes an integrated work cell 901 that coordinates the operation of the laser beam tools 902 and 904, delivery of the laser beam tools to the brittle material work piece, feed of brittle material stock, positioning precisely the brittle material, synchronized movements of the brittle material with application of the laser beam tool(s), and auxiliary functions, such as quality inspection or work area cleanliness. The integrated work cell 901 can include the functions described above within a rigid platform 906 for process stability and consistency of the predetermined and highly controllable geometric shape and/or surface morphology of the as-cut brittle material portion.

The work cell 901 described herein can be controlled by a computer numerical control (CNC) apparatus to coordinate various functions performed by the work cell 901. The control system can include a central processing unit (CPU), a software operating system (OS), and a mixture of digital and analog electronics to send and receive commands and communications with the work cell hardware. The control system can be operated substantially autonomously to take in the brittle material stock and produce brittle material portion(s) where the as-cut edge has a predetermined and controllable geometric shape and/or surface morphology.

In some embodiments, the work cell control system is coupled to a communications network. In other embodiments, the work cell control system contains an internet web server. In some other embodiments, the work cell control system includes methods of remote telemetry of the constituent functional elements and/or the brittle material processing efficacy.

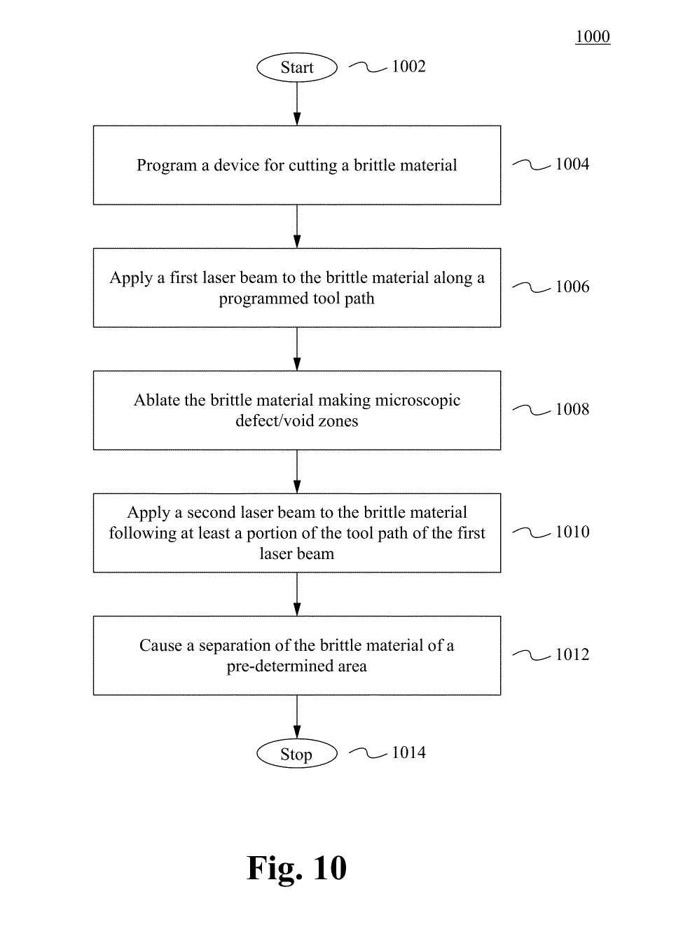

FIG. 10 is a flow chart illustrating cutting a brittle material method 1000 in accordance with some embodiments of the present invention. The method 1000 starts from a step 1002. In a step 1004, a device for cutting a brittle material is programmed. The controlling factors that can be programmed include laser delivering speed, laser temperature, type and duration of the application of the laser beams, a predetermined temperature of the material that is cut, and the temperature of the location where receives the energy of the laser beams. A person of ordinary skill in the art appreciates that any other controlling factors are able to be programmed so long as it can be used to facilitate the cutting process. In a step 1006, a first laser beam is applied to the brittle material along a programmed tool path. The first laser beam is able to be a femtosecond pulse laser beam that it generates a localized heating spot in an ultra short period on the material, such as nano-second, which avoids infusing heat to the material and in turn avoid the changes of the chemical/physical compositions caused by a thermo gradient. In a step 1008, the brittle material is modified by the first laser beam breaking down a portion of the brittle material and making microscopic defects/voids as the cutting profile lead. In a step 1010, a second laser beam, such as a long pulse or CW laser beam (continuous wave laser beam), to the brittle material following at least a portion of the tool path of the first laser beam. In a step 1012, a predetermined portion of the brittle material is separated. The process 1000 can stop at a step of 1014.

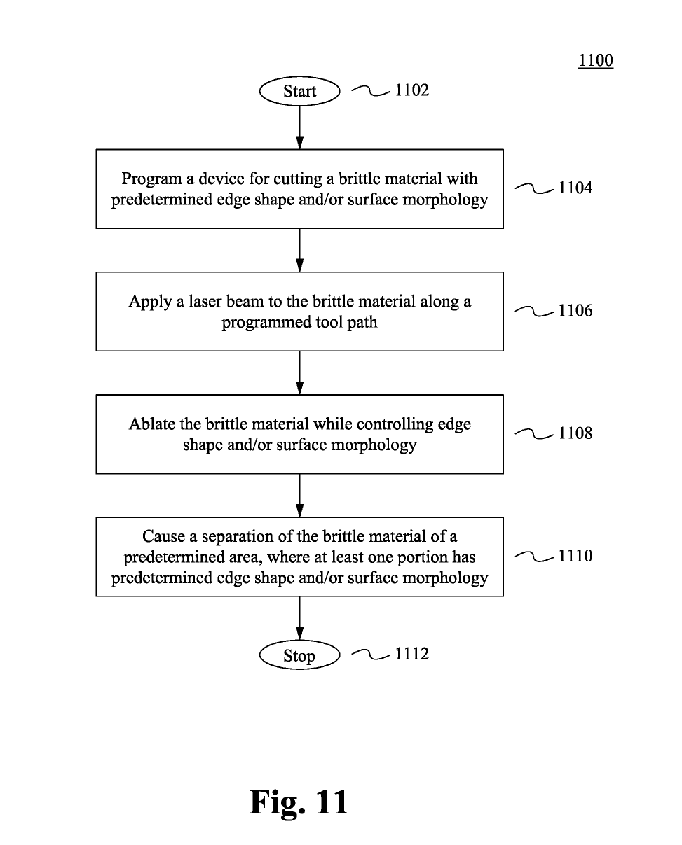

FIG. 11 is a flow chart illustrating cutting a brittle material method 1100 using a single laser in accordance with some embodiments of the present invention. The method 1100 starts from a step 1102. In a step 1104, a device is programmed for cutting a brittle material with predetermined edge shape and/or surface morphology. In a step 1106, a laser beam is applied to the brittle material along a programmed tool path. In a step 1108, the brittle material is ablated with a controlled edge shape and/or surface morphology. In some embodiments, the controlled edge shape and/or surface morphology is formed on the brittle material via the laser induced breakdown of a portion of the brittle material. In a step 1110, a separation of a predetermined area of the brittle material is caused, where at least one portion of the predetermined area has predetermined edge shape and/or surface morphology. In some embodiments, the separation is done by using the laser. In some other embodiments, the separation is done by using a mechanical force. The method 1100 stops at a step 1112.

The methods and devices disclosed herein provide many advantageous aspects in commercial and/or industrial uses such as that the surface of the as-cut brittle material using the methods and devices of the present invention does not require additional after-cut treatment process. In contrast, typical methods and devices requires many after-cut mechanical treatment steps, such as grinding, polishing, etching, annealing, chemical bath, and ion-exchange treatments.

The methods and devices disclosed herein are able to be utilized to cut any amorphous solid materials, such as glass cover for electronic devices, solar panel, ITO (indium tin oxide), soda-lime glasses, windows, and wind shield of an automobile.

In operation, the method of the present invention comprises providing a stock of brittle material and applying one or more tools to a portion of the brittle material causing the separation of the material into two or more portions in a way that precisely controls the geometric shape and/or surface morphology of the edge(s) of at least one of the separate portions.

The present invention has been described in terms of specific embodiments incorporating details to facilitate the understanding of principles of construction and operation of the invention. Such reference herein to specific embodiments and details thereof is not intended to limit the scope of the claims appended hereto. It is readily apparent to one skilled in the art that other various modifications can be made in the embodiment chosen for illustration without departing from the spirit and scope of the invention as defined by the claims.

What is claimed is:

1. A method of cutting a brittle material comprising:
a. cutting the brittle material by applying a laser; and
b. forming an edge with a surface having a predetermined edge shape and roughness.

2. The method of claim 1, wherein the laser comprises a femtosecond laser.

3. The method of claim 1, wherein the surface is substantially flat.

4. The method of claim 3, wherein the surface is perpendicular to the body of the brittle material.

5. The method of claim 3, wherein the edge comprises an oblique angle between the surface and the body of the brittle material.

6. The method of claim 1, wherein the edge comprises a tapered edge.

7. The method of claim 1, wherein the edge comprises a curved edge.

8. The method of claim 1, wherein the surface comprises chips or cracks having a depth not greater than 50 micrometers from the surface.

9. The method of claim 1, wherein the surface comprises chips or cracks having a depth not greater than 20 micrometers from the surface.

10. The method of claim 9, wherein the chips or cracks comprise a predetermined peak-to-valley depth.

11. The method of claim 1, wherein the brittle material comprises an intrinsic material bending strength greater than 200 megapascal (Mpa) after the cutting.

12. The method of claim 1, wherein the brittle material comprises an intrinsic material bending strength greater than 500 megapascal (Mpa) after the cutting.

13. The method of claim 1, wherein the brittle material comprises a borosilicate glass, a soda-lime glass, quartz, sapphire, silicon, or a combination thereof.

14. The method of claim 1, wherein the brittle material comprises a strengthened glass.

15. The method of claim 1, wherein the brittle material comprises a tempered glass.

16. The method of claim 1, wherein the brittle material retains an intrinsic bending strength after cutting.

17. A method of cutting a brittle material comprising:
a. forming apertures by breaking down the brittle material using a first laser beam;
b. forming a shape of a predetermined profile for cutting; and
c. separating a first portion of the brittle material from a second portion of the brittle material by using a second laser beam.

18. The method of claim 17, wherein the first laser beam comprises a femtosecond laser beam.

19. The method of claim 17, wherein the second laser beam comprises a femtosecond laser beam.

20. The method of claim 17, wherein the second laser beam comprises a continuous wave laser beam.

21. The method of claim 17, wherein the second laser beam comprises a wave length longer than the first laser beam.

22. The method of claim 17 further comprising programming a programmable device to form the predetermined profile.

23. The method of claim 18 further comprising automatically placing the brittle material to the device.

24. The method of claim 18 further comprising automatically removing the brittle material from the device after the using of the second laser beam.

25. The method of claim 17 further comprising flipping the brittle material.

26. The method of claim 17 further comprising combining the brittle material with an electronic device after the separating.

27. The method of claim 17 further comprising covering an electronic device to form a protective layer.

28. The method of claim 17, wherein the brittle material comprises glass, quartz, sapphire, silicon, or a combination thereof.

29. The method of claim 17, further comprising forming an edge after the using of the second laser beam.

30. The method of claim 29, wherein the edge comprises a substantially flat surface.

31. The method of claim 29, wherein the edge comprises an edge with a right angle, a tapered edge, a curved edge, or a combination thereof.

32. The method of claim 29, wherein the edge comprises chips or cracks having a depth not greater than 50 micrometers.

33. A device for cutting a brittle material comprising:
a. a femtosecond laser generating device programmed to ablate the brittle material to form a predetermined shape; and
b. a substrate holder.

34. The device of claim 33 further comprising a second laser generating device.

35. The device of claim 34, wherein the second laser generating device is programmed to separate the predetermined shape from a remaining portion of the brittle material.

36. The device of claim 34, wherein the second laser generating device comprises a continuous wave laser beam generator.

37. The device of claim 34, wherein the second laser generating device generates a laser pulse having a wave length longer than the wave length that is generated by the femtosecond laser.

38. The device of claim 34, wherein the substrate holder is configured to hold a brittle material.

39. The device of claim 37, wherein the brittle material comprises a glass.

40. The device of claim 37, wherein the predetermined shape comprises a protective cover of an electronic device.

41. The device of claim 37, wherein the electronic device comprises a mobile phone.
